(19) United States
(12) Patent Application Publication
(10) Pub. No.: US 2008/0284199 A1
(43) Pub. Date: Nov. 20, 2008

(54) Apparatus for Opening and Closing Roof of Container

(76) Inventor: Byung-jin Chun, Seoul (KR)

Correspondence Address: J.C.PATENTS, 4 VENTURE, SUITE 250, IRVINE, CA, 92618, US

(21) Appl. No.: 10/585,709

(22) PCT Filed: Sep. 9, 2004
(86) PCT No.: PCT/KR2004/002300

§ 371 Date: Jul. 10, 2006

(30) Foreign Application Priority Data
Feb. 4, 2004 (KR) 10-2004-0007186

(51) Int. Cl. B60P 7/04

(52) U.S. Cl. 296/100.03

(57) ABSTRACT

Disclosed is an apparatus for opening and closing a roof of a container for simply opening and closing a roof of a container using a sliding method without separating constitutional elements, and for opening and closing the roof by a small force. The apparatus comprises a pair of guide rails installed on top ends of both side walls of the container, respectively; cover supporting members disposed on the guide rails for supporting the cover, both ends of the cover supporting member being installed to be slid on the guide rails, respectively; sliding means for sliding the cover supporting member; and brace bars foldably connected to the cover supporting member for connecting the adjacent cover supporting members. The cover supporting member is slid along the guide rail to open and close the cover thereby.

### TECHNICAL FIELD

The present invention relates to an apparatus for opening and closing a roof of a roof opening and closing typed container, and more particularly to an apparatus for opening and closing a roof of a container for easily opening and closing the roof of the container using a sliding method.

### BACKGROUND ART

Generally, a container is a standardized carrying box for protecting goods to be transported from the outside circumstance, preventing fall of the goods, and also easily transporting various goods. It is widely used for transporting goods of exportation and importation.

The container for transporting goods is classified into a sealing typed container for sealing the remaining parts except for a door of a rear part thereof for loading and unloading the goods and a roof opening and a closing typed container for opening and closing a roof to load and unload large and heavy goods.

A conventional roof opening and closing typed container is installed with numerous roof bow sockets at equal intervals on topside rails thereof. Here, both ends of a roof bow are inserted into the sockets or drawn from the sockets, respectively. Then, a cover made of tarpaulin is covered thereon and then the girth of the cover is tied up by a fixing rope.

However, according to such a conventional container, whenever loading or unloading large-sized goods, after untying the fixing ropes and then covering or uncovering the cover, two or more workers should remove the roof bows inserted into the sockets from the sockets, respectively. Thus, there has been inconvenience according to lowering of work efficiency. Further, it is feared that an accident due to workers' careless handling happens. Further, there has been a problem in that the roof bow and the cover are frequently lost.

### DISCLOSURE OF THE INVENTION

Therefore, the invention has been made in view of the above problems, and it is an object of the invention to provide an apparatus for opening and closing a roof of a container for simply opening and closing a roof of a container using a sliding method, and for opening and closing the roof by a small force.

In order to accomplish the object of the invention, the apparatus for opening and closing a roof of a container according to the invention comprises: a pair of guide rails installed on top ends of both side walls of the container, respectively; cover supporting members disposed on the guide rails for supporting the cover, both ends of the cover supporting member being installed to be slid on the guide rails, respectively; sliding means for sliding the cover supporting member; and brace bars foldably connected to the cover supporting member for connecting the adjacent cover supporting members. The cover supporting member is slid along the guide rail to open and close the cover thereby.

Here, the guide rail includes a rail frame having a shape of “ [symbol] ”, the rail frame being installed on each top end of both side walls of the container; and a guide having a shape of “ [symbol] ”, the guide being formed on an inner side of a center part of the rail frame to guide the slide of the cover supporting member.

Further, the cover supporting member includes a bow bar for supporting the cover; roller devices connected to both ends of the bow bar, respectively, and slid along the guide rail; and a brace holder connecting the roller device and the bow bar by interposing between the bow bar and the roller device, the brace holder being connecting with the brace bar.

Further, the sliding means includes a pulley installed roatatably at a front side or a rear side of the guide rail; an opening and closing rope wrapped around the pulley, the rope having a portion hung down on the opposite outside of the pulley and both ends joined to one end of the cover supporting member positioned in the front most side or the rearmost side of the container; and a weight body for preventing the opening and closing rope from becoming loose by pulling down the opening and closing rope with its own weight, while causing the opening and closing rope to pass therethrough when pulling the opening and closing rope.

### BRIEF DESCRIPTION OF THE DRAWINGS

The above and other objects and features of the invention will become apparent from the following description of preferred embodiments taken in conjunction with the accompanying drawings, in which:

FIG. 1 is a plain view of an apparatus for opening and closing a roof of a container according to a first embodiment of the invention;

FIG. 2 is a perspective view for showing a guide rail and a roller device according to the invention;

FIG. 3 is a side view of a connecting member and a roller supporting member according to the invention;

FIG. 4 is a section view taken on line IV-IV in FIG. 3;

FIG. 5 is a section view taken on line V-V in FIG. 3;

FIGS. 6 and 7 are bottom views of a supporting plate according to the invention;

FIG. 8 is a plain view of a brace holder according to the invention;

FIG. 9 is a side view of a brace holder according to the invention;

FIG. 10 is a front view of a brace holder according to the invention;

FIG. 11 is an exploded perspective view for showing a connecting relation of a roller device, a brace holder and a bow bar according to the invention;

FIG. 12 is a bottom view of a cover that is opened and closed by an apparatus for opening and closing a roof of container according to a first embodiment of the invention;

FIG. 13 is a perspective view for showing a connecting relation of a roller device, a brace holder and a bow bar according to a second embodiment of the invention;

FIG. 14 is a side view of a connecting member and a roller supporting member of an apparatus for opening and closing a roof of a container according to a third embodiment of the invention;

FIG. 15 is a plain view of an apparatus for opening and closing a roof of a container according to a fourth embodiment of the invention;

FIG. 16 is a plain view of an apparatus for opening and closing a roof of a container according to a fifth embodiment of the invention;

FIG. 17 is a perspective view of a guide rail and a roller device shown in FIG. 16;

FIG. 18 is a plain view of an apparatus for opening and closing a roof of a container according to a sixth embodiment of the invention; and

FIG. 19 is a perspective view of a guide rail and a roller device shown in FIG. 18.

### BEST MODES FOR CARRYING OUT THE INVENTION

### Embodiment 1

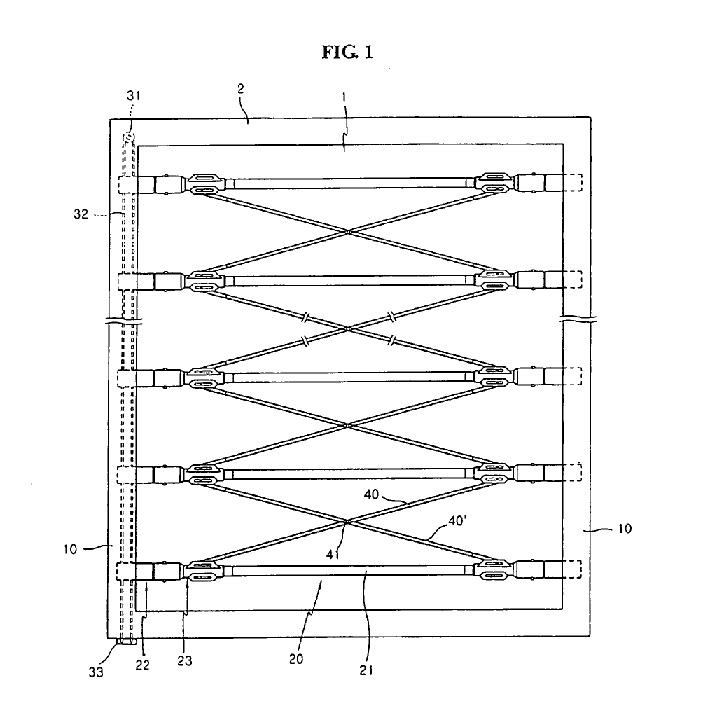

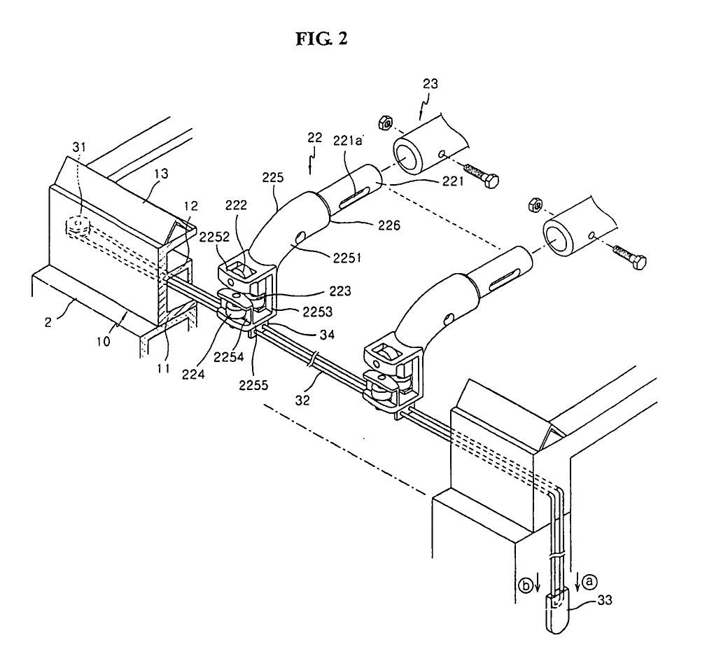

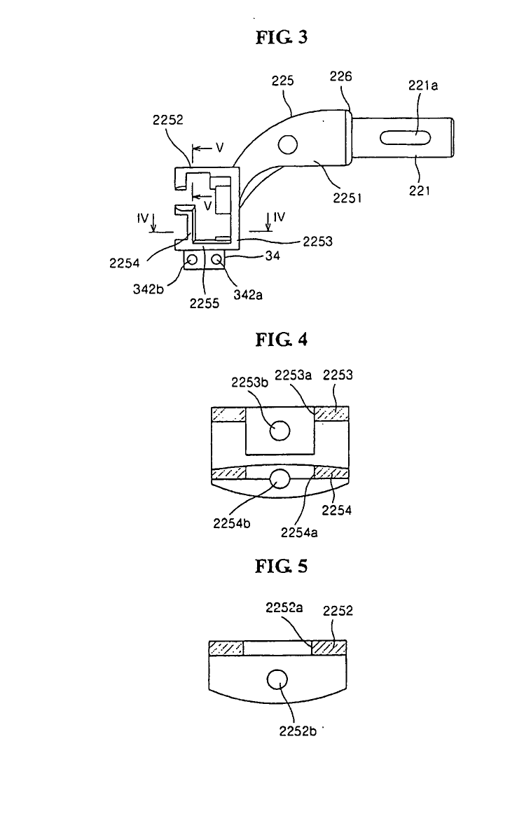

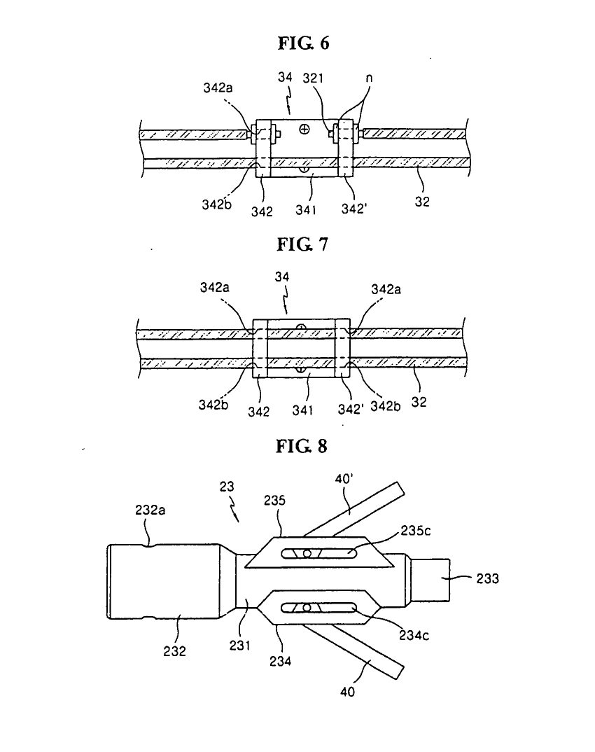

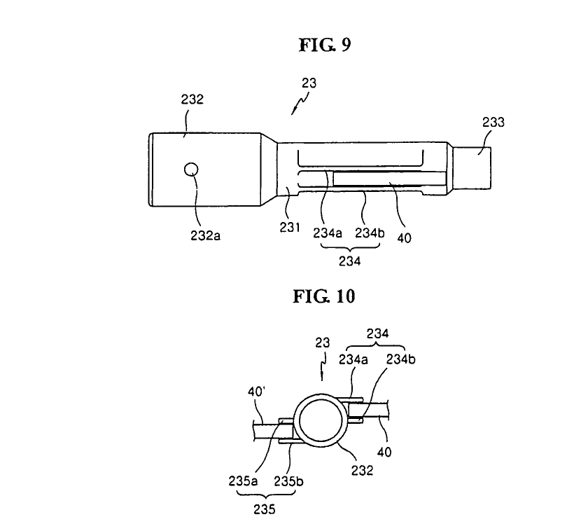

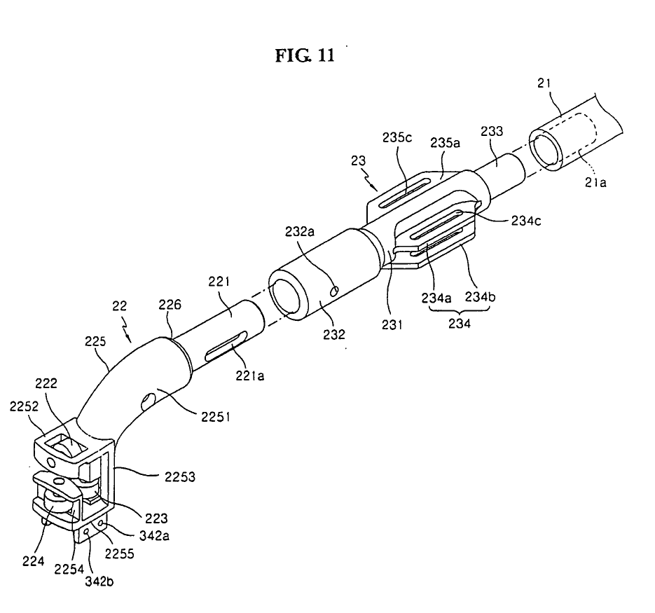

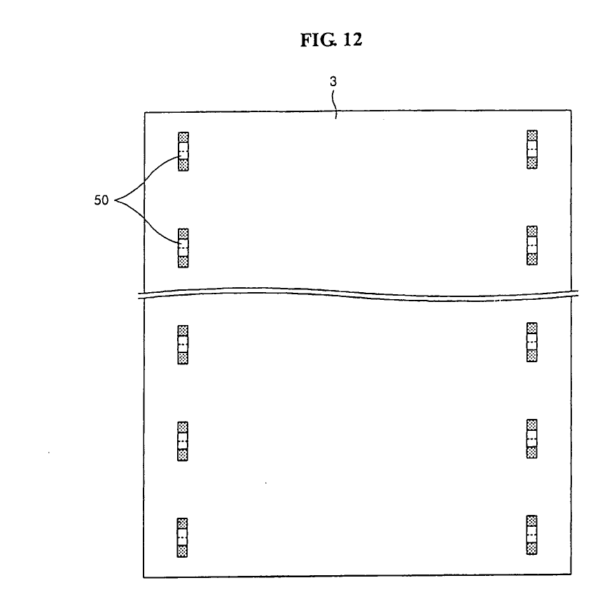

FIG. 1 is a plain view of an apparatus for opening and closing a roof of a container according to a first embodiment of the invention, FIG. 2 is a perspective view for showing a guide rail and a roller device according to the invention, FIG. 3 is a side view of a connecting member and a roller supporting member according to the invention, FIG. 4 is a section view taken on line IV-IV in FIG. 3, FIG. 5 is a section view taken on line V-V in FIG. 3, FIGS. 6 and 7 are bottom views of a supporting plate according to the invention, FIG. 8 is a plain view of a brace holder according to the invention, FIG. 9 is a side view of a brace holder according to the invention, FIG. 10 is a front view of a brace holder according to the invention, FIG. 11 is an exploded perspective view for showing a connecting relation of a roller device, a brace holder and a bow bar according to the invention, and FIG. 12 is a bottom view of a cover that is opened and closed by an apparatus for opening and closing a roof of container according to a first embodiment of the invention.

Referring to FIG. 1, an apparatus 1 for opening and closing a roof of a container according to a first embodiment of the invention opens and closes a cover 3, which is joined to a top end of a container 2 opened upward, for forming a roof of the container 2, a pair of guide rails 10 that are installed on top ends of both side walls of the container 2, respectively, numerous cover supporting members 20 that are slid along guide rails 10 while supporting the cover 3, a sliding means for sliding the cover supporting member 20 along the guide rail 10, and brace bars 40 and 40′ that connect the cover supporting members 20 adjacent to them and are folded along with the cover supporting members 20, respectively.

As shown in FIG. 2, the guide rail 10 consists of a rail frame 11 having a shape of “ [symbol] ”; which is installed lengthily on each top end of both side walls, and a guide 12 having a shape of [symbol] which is extended to an inner side of a center part of the rail frame 11, for guiding the slide of the cover supporting member 20.

Further, the rail frame 11 is lengthily mounted with a protecting member 13 on an upper surface thereof. The protecting member 13 prevents a container that is piled on an upper side of the container 2 when the container 2 is piled from contacting the rail frame 11 and the cover 3

As shown in FIG. 1, the cover supporting member 20 consists of a bow bar 21 for supporting the cover 3, roller devices 22 that are connected both ends of the bow bar 21, respectively, and are slid along the guide rail 10, and a brace holder 23 that connects the roller device 22 and the bow bar 21 by interposing between the bow bar 21 and the roller device 22 and causes both ends of the brace bars 40 and 40′ to be rotatably connected to the brace holder 23.

Here, the roller device 22, as shown in FIG. 2, consists of a joining member 221 joined to the brace holder 23, a plurality of rollers 222, 223 and 224 that are slid along an upper surface and both side surfaces of the guide 12 of the guide rail 10, respectively, and a roller supporting member 225, which is extended from the connecting member 221, for ratatably supporting the rollers 222, 223 and 224.

At this time, the joining member 221 of the roller device 22 has a shape of a circular cylinder to insert into an inserting hollow part 232 of the brace holder 23 that will be described hereinafter. The joining member 221 is formed with an elongated hole 221a which a fastening member (not shown) passes through when the joining member 221 is inserted into the inserting hollow part 232 of the brace holder 23. The elongated hole 221a is lengthily formed along the length direction of the joining member 221 so that it may cause the brace holder 23 to be slid right and left within the length scope of the elongated hole 221a when the cover supporting member 20 slides along the guide rail 10.

As such, the brace holder 23 slides in the length direction by the elongated hole 221a that is formed on the joining member 221 of the roller device 22. Thus, even in case that both ends of the cover supporting member 20 slides having a deflection or either end of the cover supporting member 20 gets bent by a shock of the outside, the roller device 22 is normally slid within a deflection that is formed by the elongated hole 221a of the joining member 221.

Further, the roller supporting member 225 consists of a body 2251 that is extended from the joining member 221, a first roller supporting part 2252, which is horizontally extended to the front end of the body 2251, for rotatably supporting the roller 222 that is slid along the upper surface of the guide 12, a second roller supporting part 2253, which is extended vertically downward from the front end of the body 2251, for roatatably supporting the roller 223 that is slid along one side surface of the guide 12, a third roller supporting part 2254, which is spaced in parallel with the second roller supporting part 2253 while interposing a lower part of the guide 12 therebetween, for rotatably supporting the roller 224 that is slid along the other side surface of the guide 12, and a connecting part 2255 for connecting a lower end of the second roller supporting part 2253 and a lower end of the third roller supporting part 2254.

Here, each of the roller supporting parts 2252, 2253 and 2254, as shown in FIGS. 4 and 5, is formed with a center part having a projected rounding shape not to directly contact the guide 12 having the shape of “ [symbol] ” when both ends of the cover supporting member 20 are slid having a little deflection without moving horizontally.

If each of the roller supporting parts 2252, 2253 and 2254 has a flat shape instead of the rounding shape, it is feared that both sides of the respective roller supporting part 2252, 2253, 2254 are directly contacted to the guide 12 when both ends of the cover supporting member 20 are slid having a deflection. In this case, the cover supporting member 20 is not easily slid due to a friction force generated by contact between the respective roller supporting member 2252, 2253, 2254 and the guide 12.

Meanwhile, a respective one of the rollers 222, 223 and 224, as shown in FIG. 2, is rotatably mounted on an outer side of a respective one of the roller supporting parts 2252, 2253 and 2254. Further, a center part of a respective one of the roller supporting parts 2252, 2253 and 2254 is formed with a respective one of through holes 2252a, 2253a and 2254a. A part of a respective one of the rollers 222, 223 and 224 passes through a respective one of the through holes 2252a, 2253a and 2254a and then projects to the inside of a respective one of the roller supporting parts 2252, 2253 and 2254.

Further, referring to FIGS. 4 and 5, a front part and a rear part of the first roller supporting part 2252 and an upper part and a lower part of a respective one of the second and third roller supporting parts 2253 and 2254 are formed with a respective one of fixing holes 2252b, 2253b and 2254b for receiving and fixing both ends of a roller shaft of a respective one of the rollers 222, 223 and 224.

Further, a stepped surface 226 is formed between the body 2251 of the roller supporting member 225 and the joining member 221. That is, since a cross-sectional area of the joining member 221 is formed smaller than that of the body 225, when the joining member 221 is inserted into the inserting hollow part 232 of the brace holder 23, the extent of inserting is restricted by the stepped surface.

The brace holder 23, as shown in FIGS. 8 to 10, consists of a holder body 231 having a cylindrical shape, the inserting hollow part 232 having a cylindrical shape, which is extended to one end of the holder body 231, for receiving the joining member 221 of the roller device 22, an inserting projection 233, which is extended to the other end of the holder body 231, for inserting into an inserting groove 21a formed at both ends of the bow bar 21, and a pair of wings 234 and 235 which are extended in both directions of the outer side of the holder body 231, respectively, and are rotatably joined to the brace bars 40 and 40′, respectively.

At this time, the inserting hollow part 232 is formed with a through hole 232a that a fastening member passes through when the joining member 221 is inserted and joined.

Further, since, when opening the cover 3, two brace bars 40 and 40′ should be overlapped up and down while the adjacent cover supporting members 20 are contacted each other, the pair of wings 234 and 235 is formed having different heights, respectively.

If the wings 234 and 235 are having the same height, it is difficult to overlap the brace bars 40 and 40′ and also it is feared that the brace bars 40 and 40′ are damaged even if they are overlapped.

Meanwhile, the wings 234 and 235 have pairs of wing pieces 234a, 234b, 235a and 235b, respectively. The pair of wing pieces is spaced up and down and receives the end of a respective one of the brace bars 40 and 40′. Further, the respective pair of the wing pieces 234a, 234b, 235a and 235b has a respective one of elongated holes 234c and 235c through which a fastening member (not shown) for joining the end of a respective one of the brace bars 40 and 40′ to the respective pair of the wing pieces 234a, 234b, 235a and 235b passes.

As such, the reason why the wings 234 and 235 are formed with the elongated holes 234c and 235c, respectively, is that, when the brace bars 40 and 40′ are unfolded and then folded, the brace bars 40 and 40′ are smoothly folded by forming a sliding space so that the end of a respective one of the brace bars 40 and 40′ may slide in both directions within the scope of a respective one of the elongated holes 234c and 235c.

The sliding means, as shown in FIGS. 1 and 2, consist of a pulley 31 that is rotatably installed at a rear side of the guide rail 10, an opening and closing rope 32 that is wrapped around the pulley 31 and has a portion that is hung down on the opposite outside of the pulley 31, that is, on the front side of the container 2 and both ends that are joined to one end of the cover supporting member 20 positioned in the rearmost side of the container 2, a weight body 33 for preventing the opening and closing rope 32 from becoming loose by pulling down the opening and closing rope 32 with its own weight, while passing through the opening and closing rope 32 when pulling the opening and closing rope 32, and a supporting plate 34 that is mounted at a bottom surface of a connecting part 2255 of the roller device 22 and that is formed with a pair of rope passing holes 342a and 342b, which is spaced right and left, so that the opening and closing rope 32 may pass through the rope passing holes.

At this time, the supporting plate 34, as shown in FIGS. 6 and 7, consists of a fixing part 341 that is joined to the bottom surface of the connecting part 2255 of the roller device 22 by a fastening means such as a bolt and the like, and a pair of rope passing part 342 and 342′ that is extended vertically downward from both ends of the fixing part 341 and has the rope passing holes 342a and 342b that are faced each other.

Further, both ends of the opening and closing rope 32 are joined with fixing members 321 that is fixed to the supporting plate 34, respectively. The fixing member 321, as shown in FIG. 6, is fixed to the supporting plate 34 that is mounted on the roller device 22 of the cover supporting member 20 positioned in the rearmost side of the container 2. Further, the fixing member 321 is formed with a screw thread on an outer surface thereof. Each of the fixing members 321 passes through the rope passing hole 342a of the rope passing parts 342 and 342′ that are faced each other and then is screwed by a nut n at both surfaces of a respective one of the rope passing parts 342 and 342′ to be firmly fixed to a respective one of the rope passing parts 342 and 342′.

Meanwhile, the pulley 31 installed at the rear side of the guide rail 10 may be installed at the front side of the guide rail 10 by changing the position thereof. In this case, a portion of the opening and closing rope 32 is hung down in the rear side of the container 2, and the weight body 33 also is positioned in the rear side of the container 2.

Further, the both ends of the opening and closing rope 32 fixed to the cover supporting member 20 that is positioned at the rearmost side of the container 2 may be fixed to the cover supporting member 20 that is positioned at the frontmost side of the container 2 by changing the position thereof.

As such, even if the position for installing the pulley 31 and the position for fixing the opening and closing rope 32 are changed, the direction of opening and closing the cover 3 only is changed, and the opening and closing operation is performed in the same manner.

Referring again FIG. 1, when sliding the rearmost cover supporting member 20 using the sliding means, the brace bars 40 and 40′ causes all the cover supporting members 20 to be slid successively in the same direction. There are two brace bars between the cover supporting members 20 that are adjacent each other. Each of the brace bars 40 and 40′ is rotatably connected at the center part thereof by a hinge 41. Further, the end of a respective one of the brace bars 40 and 40′ is rotatably joined to each of the wings 234 and 235 of the brace holder 23 by a fastening member.

Meanwhile, reference number 50 indicates velcro, which is arrayed in the both side of the bottom surface of the cover 3, for detachably joining the cover 3 to the both ends of the respective supporting member 20. At this time, the joining means for joining the cover 3 to the cover supporting member 20 may use a rope for joining by making a knot and the like as well as the velcro.

The operation of the apparatus for opening and closing the roof of the container according to the first embodiment of the invention will be described herein below.

First, if a worker pulls at the opening and closing rope 32 in a direction of an arrow “\textcircled{a}” in FIG. 2, the rearmost cover supporting member 20 joined to both ends of the opening and closing rope 32 is slid forwardly. Then, the cover supporting member 20 is slid contacting with another cover supporting member 20 which is adjacent to it. As s result, the two cover supporting members 20 are slid forwardly.

Thus, if the worker continuously pulls at the opening and closing rope 32 in a direction of an arrow “\textcircled{a}”, all the cover supporting members 20 except for the rearmost cover supporting member 20 are pushed by the rearmost cover supporting member 20 and then are slid forwardly. As a result, the cover 3 supported by the cover supporting member 20 is opened.

As such, the brace bars 40 and 40′ positioned between the cover supporting members 20 are folded together, while the cover supporting members are slid forwardly. At this time, since the both ends of a respective one of the brace bars 40 and 40′ are slid in the both direction along the elongated holes 234c and 235c formed in the wings 234 and 235 of the brace holder 23, respectively, each of the brace bars 40 and 40′ are smoothly folded.

Further, since each of, the wings 234 and 235 of the brace holder 23 has a different height, the end of a respective one of the brace bars 40 and 40′ is smoothly folded without being damaged when each of the brace bars 40 and 40′ joined to the wings are folded.

After passing through the above procedures, a worker opens the cover 3 and then loads goods into the container 2 or unloads goods from the container 2. Then, if the worker continuously pulls at the opening and closing rope 21 in the direction of an arrow “\textcircled{b}” in FIG. 3, all the cover supporting members 20 is slide backwardly while the rearmost cover supporting member 20 that has been slid forwardly is slid backwardly. Then, if the rearmost cover supporting member 20 is fully slid backwardly, each of the cover supporting members 20 is arrayed at regular intervals, and the cover 3 joined to each of the cover supporting members 20 closes the opened upper part of the container 2.

As such, while the cover 3 is closed, the end of a respective one of the brace bars 40 and 40′ is slid in the opposite direction thereof contrary to when it is folded. Further, if the end of a respective one of the brace bars 40 and 40′ is freely moved in full, the brace holder 23 also is slid in the opposite direction thereof.

Meanwhile, while the cover 3 is opened or closed, the roller devices 22 which are installed at the both ends of the cover supporting member 20, respectively, may be slid having a deflection without being slid in parallel. However, since each of the roller supporting parts 2252, 2253 and 2254 of the roller device 22 is formed to have a rounded shape and the entire length of the cover supporting member 20 becomes longer as long as the deflection of the both ends of the cover supporting member 20 while the brace holder 23 is slid along the elongated hole 221a formed in the joining member 221 of the roller device 22, the both sides of a respective one of the roller supporting parts 2252, 2253 and 2254 are not contacted to the guide 12 of the guide rail 10 so that the respective cover supporting member 20 is smoothly slid without friction.

Further, the cover 3 is detachably joined to the cover supporting member 20. Thus, in case that the goods loaded in the container 2 are upwardly projected from the container 2, after making the cover supporting members 20 close together in the front side of the container 2 and then separating the cover 3 from the cover supporting members 20, the upper side of the container 2 may be covered using only the cover 3. At this time, the edge of the cover 3 may be fixed using a rope and the like and outside rings fixed on the container 2.

### Embodiment 2

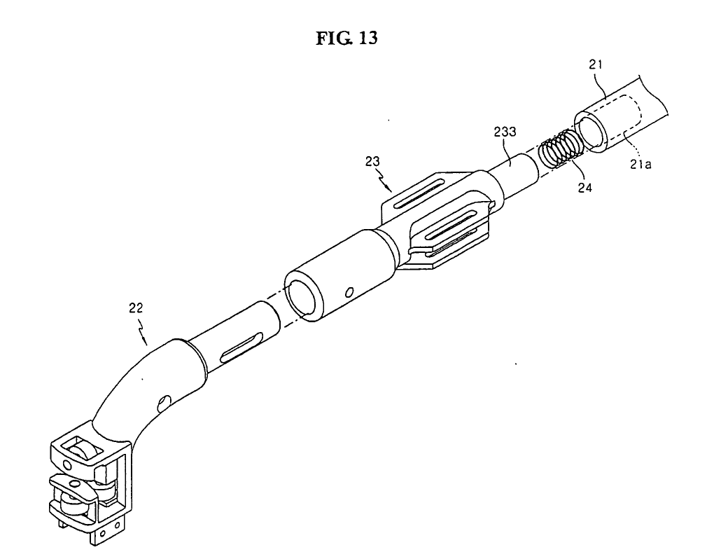

FIG. 13 is a perspective view for showing a connecting relation of a roller device, a brace holder and a bow bar according to a second embodiment of the invention. Here, elements having the same reference number in FIGS. 1 to 12 refer to elements having a similar function.

As shown in FIG. 13, according to an apparatus for opening and closing a roof of a container of the second embodiment of the invention, a spring 24 for applying force in the direction of pushing the inserting projection 233 of the brace holder 23 outwardly is inserted into the inserting hollow 21a formed on the both ends of the bow bar 21 of the cover supporting member 20.

Therefore, when the both ends of the cover supporting member 20 is slid having a deflection, the brace holder 23 is smoothly slid in the both directions along the joining member 221 of the roller device 22 by an elastic force of the spring 24 and the entire length of the cover supporting member 20 becomes longer as much as the deflection. As a result, the cover supporting member 20 is smoothly slid.

Since the operation of the apparatus for opening and closing the roof of the container according to the second embodiment of the invention is identical with the operation of the first embodiment of the invention, the description thereof will be omitted hereinafter.

### Embodiment 3

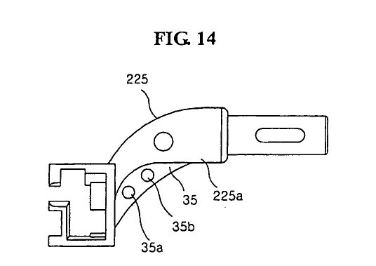

FIG. 14 is a side view of a joining member and a roller supporting member of an apparatus for opening and closing a roof of a container according to a third embodiment of the invention. Here, elements having the same reference number in FIGS. 1 to 14 refer to elements having a similar function.

As shown in FIG. 14, according to the apparatus for opening and closing the roof of the container of the third embodiment of the invention, a supporting plate 33 for supporting the opening and closing rope 32 of the sliding means for sliding the cover supporting member 20 is integrally formed to the bottom surface of the body 2251 of the roller supporting member 225.

Further, the supporting plate 35 is formed with a pair of rope passing holes 35a and 35b for receiving the opening and closing rope 32, wherein the holes are spaced right and left on the supporting plate 35.

Further, although it is not shown in the drawing, fixing members (not shown) fixed to the supporting plate 35 are joined to the both ends of the opening and closing rope 32, respectively, wherein the supporting member is fixed to the supporting plate 35 of the cover supporting member 20 positioned at the rearmost side of the container 2.

Since the operation of the apparatus for opening and closing the roof of the container according to the third embodiment of the invention is identical with the operation of the first embodiment of the invention, the description thereof will be omitted hereinafter.

### Embodiment 4

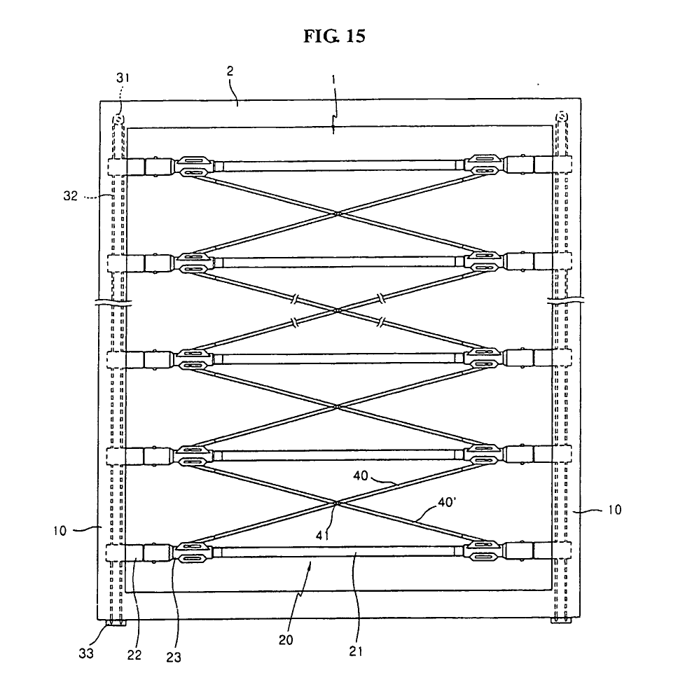

FIG. 15 is a plain view of an apparatus for opening and closing a roof of a container according to a fourth embodiment of the invention. Here, elements having the same reference number in FIGS. 1 to 14 refer to elements having a similar function.

As shown in FIG. 15, according to the apparatus for opening and closing the roof of the container of the fourth embodiment of the invention, the sliding means for sliding the cover supporting members 20 is on both sides of the container, thereby sliding the cover supporting members 20 at the same speed on the both sides.

In this case, two workers should pull at the opening and closing rope 32 at the same speed in the both sides of the container 2. If each of the workers pulls at the opening and closing rope 32 at a different speed, since the cover supporting member 20 may be inclined, they are not slid smoothly.

Since the operation of the apparatus for opening and closing the roof of the container according to the fourth embodiment of the invention is identical with the operation of the first embodiment of the invention, the description thereof will be omitted hereinafter.

### Embodiment 5

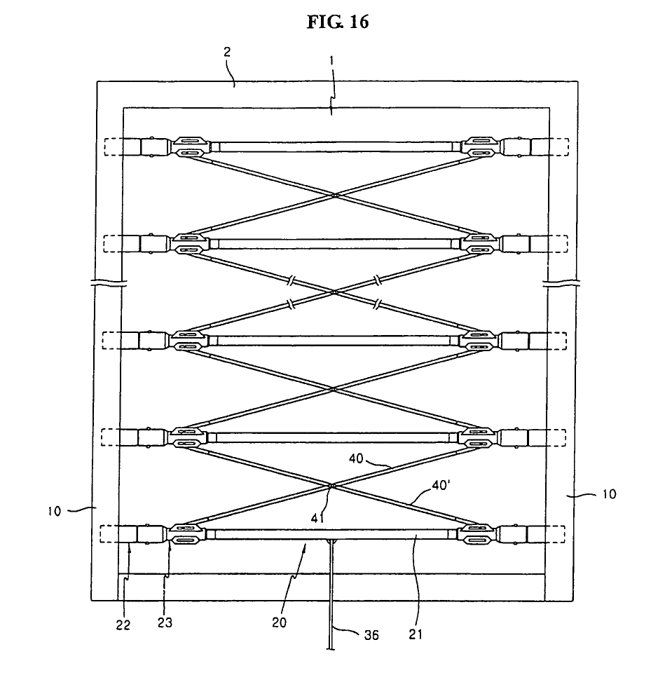

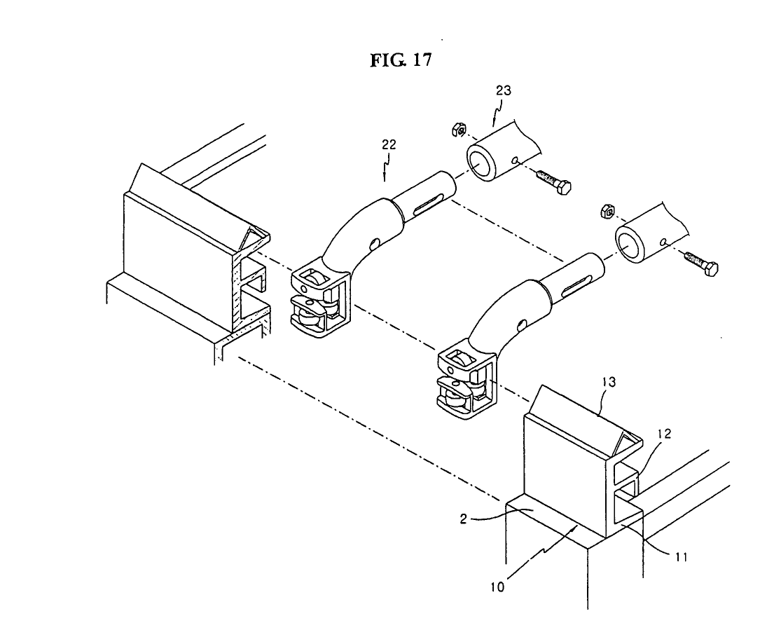

FIG. 16 is a plain view of an apparatus for opening and closing a roof of a container according to a fifth embodiment of the invention, and FIG. 17 is a perspective view of a guide rail and a roller device shown in FIG. 16. Here, elements having the same reference number in FIGS. 1 to 15 refer to elements having a similar function.

As shown in FIGS. 16 and 17, according to the apparatus for opening and closing the roof of the container of the fifth embodiment of the invention, the center of the bow bar 21 of the cover supporting member 20 positioned at the frontmost side or the rearmost side of the container 2 is tied with an opening and closing rope 36. The cover 3 can be opened or closed by pulling at the opening and closing rope 36.

That is, as shown in FIG. 16, in case of tying the center of the bow bar 21 of the cover supporting member 20 positioned at the frontmost side with the opening and closing rope 36, when opening the cover 3, a worker directly pushes the cover supporting members 20 backwardly or pulling at the opening and closing rope 36 in the rear side of the container 2 after hanging down the opening and closing rope to the rear side of the container 2. On the contrary, when closing the cover 3, the worker pulls at the opening and closing rope 36 in the front side of the container 2.

Meanwhile, if the frontmost side of the guide rail 10, as shown in FIG. 17, is opened, a part of the cover supporting member 20 is separated from another cover supporting member 20 that is adjacent to the cover supporting member 20 so that some of the cover supporting members 20 are not caught by goods that are loaded in the container 2 when the loaded goods are projected upwardly from the container 2, thereby drawing out the cover supporting member 20 through the frontmost side of the guide rail 10, which is opened.

The elements of the apparatus for opening and closing the roof of the container according to the fifth embodiment of the invention are identical to the elements of the first embodiment of the invention except that the sliding means of the first embodiment is changed into the opening and closing rope 36. Thus, since, referring to the operation of the first embodiment, the operation of the fifth embodiment may be understood, the description thereof will be omitted hereinafter.

### Embodiment 6

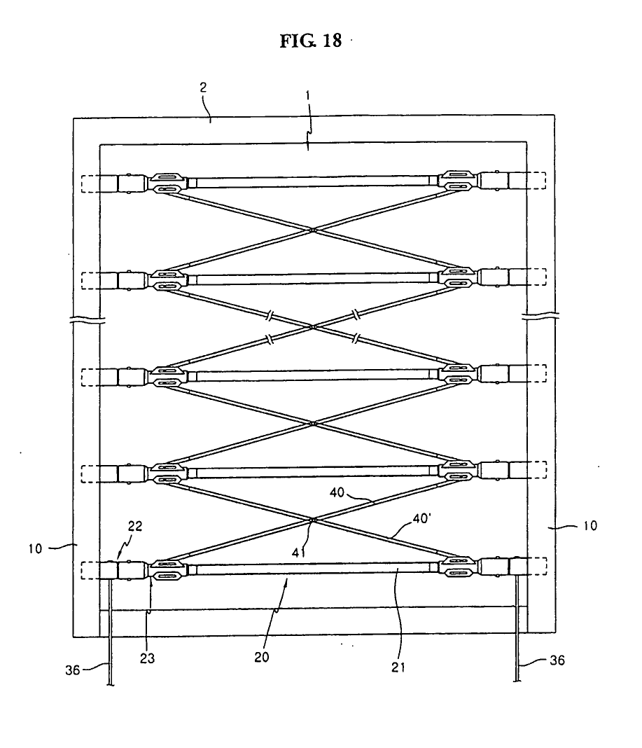

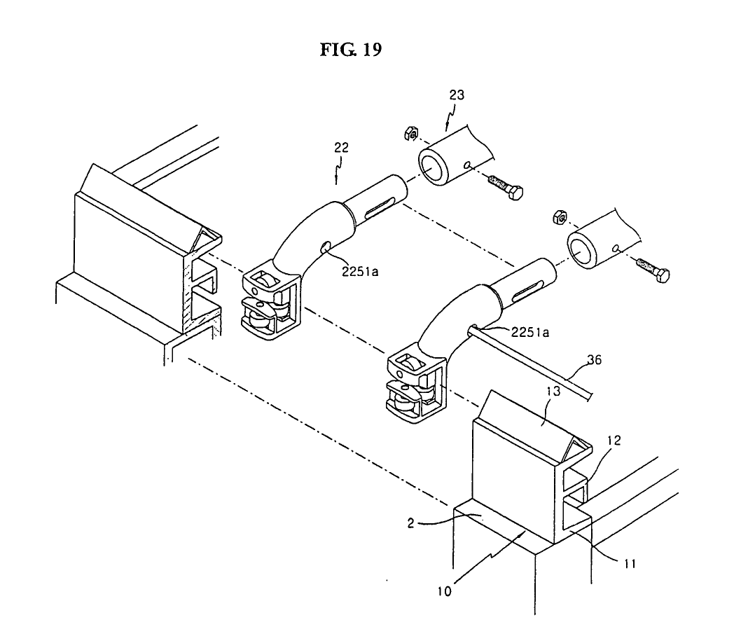

FIG. 18 is a plain view of an apparatus for opening and closing a roof of a container according to a sixth embodiment of the invention, and FIG. 19 is a perspective view of a guide rail and a roller device shown in FIG. 18. Here, elements shown in FIGS. 18 and 19 having the same reference number described in FIGS. 1 to 17 refer to elements having the same function.

As shown in FIGS. 18 and 19, according to the apparatus for opening and closing the roof of the container of the sixth embodiment of the invention, the body 2251 of the roller device 22 which is positioned at either side of the bow bar 21 of the cover supporting member 20 positioned at the frontmost side or the rearmost side of the container 2 is provided with a through hole 2251a which the opening and closing rope 36 passes through. The opening and closing rope 36 is fixed in the through hole 2251a after passing through the through hole 2251a. The cover 3 can be opened or closed by pulling at the opening and closing rope 36.

That is, as shown in FIGS. 18 and 19, in case of tying the body 2251 of the roller device 22 positioned at the frontmost side with the opening and closing rope 36, when opening the cover 3, two workers simultaneously pull at the opening and closing rope 36 in the rear side of the container 2 after hanging down the opening and closing rope to the rear side of the container 2. On the contrary, when closing the cover 3, the workers pull at the opening and closing rope 36 in the front side of the container 2 after hanging down the opening and closing rope to the front side of the container 2.

The elements of the apparatus for opening and closing the roof of the container according to the six embodiment of the invention are identical to the elements of the first embodiment of the invention except that the sliding means of the first embodiment is changed into the opening and closing rope 36. Thus, since the operation of the sixth embodiment may be understood with reference to the operation of the first embodiment, the description thereof will be omitted hereinafter.

### INDUSTRIAL APPLICABILITY

From the foregoing, according to the apparatus for opening and closing the roof of the container, the roof of the container can be easily opened and closed by the sliding method without separating the constitutional elements. Thus, the operation efficiency is enhanced, and the loss of the elements is prevented. Further, manpower for opening and closing the roof can be minimized since the sliding means can be operated even by small force.

Further, each of the roller supporting parts of the roller device has a rounding shape, and the brace holder is slid along the elongated hole formed on the connecting member of the roller device so that the entire length of the cover supporting member becomes longer as long as the deflection of the both ends of the cover supporting member. As a result, the both sides of the roller supporting part are not contacted to the guide of the guide rail so that the cover supporting member is smoothly slid without friction.

1. An apparatus for opening and closing a roof of a container, the roof being formed by joining a cover to an opened top end of the container, the apparatus comprising:
a pair of guide rails installed on top ends of both side walls of the container, respectively;
cover supporting members disposed on the guide rails for supporting the cover, both ends of the cover supporting member being installed to be slid on the guide rails, respectively;
sliding means for sliding the cover supporting member; and brace bars foldably connected to the cover supporting member for connecting the adjacent cover supporting members,
whereby the cover supporting member is slid along the guide rail to open and close the cover.

2. The apparatus according to claim 1, wherein the guide rail includes:
a rail frame having a shape of “ [symbol] ”, the rail frame being installed on each top end of both side walls of the container; and
a guide having a shape of [symbol] the guide being formed on an inner side of a center part of the rail frame to guide the slide of the cover supporting member.

3. The apparatus accounting claim 2, wherein the cover supporting member includes:
a bow bar for supporting the cover;
roller devices connected to both ends of the bow bar, respectively, and slid along the guide rail; and
a brace holder connecting the roller device and the bow bar by interposing between the bow bar and the roller device, the brace holder being connecting with the brace bar.

4. The apparatus accounting claim 3, wherein the roller device includes:
a joining member joined to the brace holder;
a plurality of rollers slid along upper surface and both side surfaces of the guide of the guide rail, respectively; and
a roller supporting member extended to the connecting member to rotatably support each of the rollers.

5. The apparatus accounting claim 4, wherein the roller supporting member includes:
a body extended from the joining member;
a first roller supporting part horizontally extended to the front end of the body to rotatably support the roller slid along the upper surface of the guide;
a second roller supporting part extended vertically downward from the front end of the body to roatatably support the roller slid along one side surface of the guide; and
a third roller supporting part connected to the lower end of the second rollers supporting part to be spaced in parallel with the second roller supporting part, thereby to rotatably support the roller slid along the other side surface of the guide.

6. The apparatus accounting claim 5, wherein each of the roller supporting parts is formed with a center portion having a projected rounding shape toward the guide.

7. The apparatus accounting claim 6, wherein the brace holder includes:
a holder body having a cylindrical shape;
an inserting hollow part extended to one end of the holder body to receive and fasten the joining member;
an inserting projection extended to the other end of the holder body to insert into an inserting groove formed at both ends of the bow bar; and
a pair of wings extended in both directions from the side portion of the holder body to join with the brace bars, respectively.

8. The apparatus accounting claim 7, wherein a stepped surface for restricting the insertion of the joining member is formed between the joining member and the roller supporting member, the joining member being formed with an elongated hole which a fastening member for joining the joining member to the inserting hollow part passes through, the elongated hole being formed in the longitudinal direction of the joining member.

9. The apparatus accounting to claim 7, wherein each of the wings is formed having a different height.

10. The apparatus accounting to claim 9, wherein the apparatus further comprises an elastic member inserted into an inserting hollow of the bow bar to apply force in the direction of pushing the inserting projection outwardly.

11. The apparatus according to claim 3, wherein the sliding means includes:
a pulley installed roatatably at a front side or a rear side of the guide rail;
an opening and closing rope wrapped around the pulley, the rope having a portion hung down on the opposite outside of the pulley and both ends joined to one end of the cover supporting member positioned in the front most side or the rearmost side of the container; and
a weight body for preventing the opening and closing rope from becoming loose by pulling down the opening and closing rope with its own weight, while causing the opening and closing rope to pass therethrough when pulling the opening and closing rope.

12. The apparatus according to claim 11, wherein the sliding means further includes a supporting plate provided with the roller device, the supporting plate being formed with a pair of rope passing holes spaced right and left for causing the opening and closing rope to pass therethrough.

13. The apparatus according to claim 3, wherein the sliding means is on opening and closing rope connected to the center of the bow bar of the cover supporting member positioned at the frontmost side or the rearmost side of the container in order to open and close the cover by pulling at the opening and closing rope.

14. The apparatus according to claim 3, wherein the sliding means is a pair of opening and closing ropes respectively connected to the roller devices to open and close the cover when two workers simultaneously pull at the ropes frontward or rearward.

15. The apparatus according to claim 1, wherein the apparatus further comprises a joining means arrayed right and left on a bottom surface of the cover to detachably join the cover to the cover supporting member.

16. The apparatus according to claim 15, wherein the joining means is velcro.
